(19) United States
(12) Patent Application Publication
(10) Pub. No.: US 2010/0095283 A1
(43) Pub. Date: Apr. 15, 2010

(54) Migration Apparatus Which Convert Application Program of Mainframe System into Application Program of Open System and Method for Thereof

(75) Inventors: Kang Ho Lee, Seoul (KR); Yong Tae Kim, Seoul (KR); Sang Woong Jeon, Seoul (KR); Yun Hee Hwang, Seoul (KR); Min Ho Lee, Seoul (KR); Hee Sang Yun, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: SAMSUNG SDS CO., LTD., Seoul (KR)

(21) Appl. No.: 12/445,564

(22) PCT Filed: Dec. 8, 2006
(86) PCT No.: PCT/KR06/05328

§ 371 Date: Apr. 14, 2009

(30) Foreign Application Priority Data
Oct. 17, 2006 (KR) 10-2006-0100778

(51) Int. Cl. G06F 9/45; G06F 9/44

(52) U.S. Cl. 717/137; 717/140; 717/162

(57) ABSTRACT

Provided are a migration apparatus and method for converting an application program of a mainframe system into an appropriate application program for an open system. The migration apparatus includes: a source obtaining module connected with the mainframe system, and decoding and obtaining sources of work-specific application programs made of Extended Binary Coded Decimal Interchange Code (EBCDIC) in binary form; a code conversion module converting the respective sources of the work-specific application programs obtained by the source obtaining module into American Standard Code for Information Interchange (ASCII) code, hexadecimal characters being converted to correspond to ASCII code using a previously set hexadecimal code conversion table; a compiling and link processing module compiling the sources of the work-specific application programs converted by the code conversion module and then bundling the compiled sources of the work-specific application programs with corresponding work application programs; and an executable file generation module generating executable files in binary form from the work-specific application programs processed by the compiling and link processing module to execute them in an environment of the open system. The migration apparatus and method efficiently reuse a conventionally used application program via the rehosting process of converting a mainframe system into an open system.

### TECHNICAL FIELD

The present invention relates to a migration apparatus and method for reusing and converting an application program used in a mainframe system into an appropriate application program for an open system.

### BACKGROUND ART

In general, mainframe systems have been used to process data within large corporations and governmental organizations.

The term, mainframe system, is industrial terminology indicating a large-scale computer manufactured by a large company, e.g., IBM Corporation. Mainframe systems are mainly used for performing computations required for the business activities of large companies, such as large corporations and financial institutions, and are configured according to a centralized computing method rather than a distributed computing method.

The cost of such a mainframe system is high and rapidly increases every year. For this reason, mainframe system environments are recently being replaced by open system environments, e.g., UNIX or Linux, which are designed to enable linkage between hardware (H/W) and software (S/W) of different computer manufacturing companies, and so on.

However, totally reestablishing a conventionally used mainframe system environment as an open system environment is very costly and takes a long time.

To solve these problems, rehosting solutions have lately been developed which, when converting a mainframe system environment into an open system environment, do not reestablish the entire system but convert H/W and S/W in the conventional mainframe system environment into H/W and S/W in an open system environment using middleware, a compiler solution, etc., and reuse the H/W and S/W by a migration operation of an application program and data.

According to such rehosting solutions, however, during the migration operation of an application program, many errors occur due to a difference between code systems applied to a mainframe system and an open system.

### DISCLOSURE OF INVENTION

### Technical Problem

The present invention is directed to a migration apparatus and method that minimize errors using various code conversion tables and rapidly convert an application program used in a mainframe system into an appropriate application program for an open system.

### Technical Solution

One aspect of the present invention provides a migration apparatus for converting work-specific application programs of a mainframe system into appropriate work-specific application programs for an open system, the migration apparatus comprising: a source obtaining module connected with the mainframe system, and decoding and obtaining sources of the work-specific application programs made of Extended Binary Coded Decimal Interchange Code (EBCDIC) in binary form; a code conversion module converting the respective sources of the work-specific application programs obtained by the source obtaining module into American Standard Code for Information Interchange (ASCII) code, hexadecimal characters being converted to correspond to ASCII code using a previously set hexadecimal code conversion table; a compiling and link processing module compiling the sources of the work-specific application programs converted by the code conversion module and then bundling the compiled sources of the work-specific application programs with corresponding work application programs; and an executable file generation module generating executable files in binary form from the work-specific application programs processed by the compiling and link processing module to execute them in an environment of the open system.

Here, the code conversion module may convert special characteristics, e.g., “[”, “]”, and “|”, to correspond to ASCII code using a previously set special-character code conversion table.

The code conversion module may convert variables, e.g., NAME, PREFETCH, AUTO, and CRT, used as reserved words in the open system to correspond to ASCII code using a previously set reserved-word code conversion table.

The code conversion module may convert full-width characters to correspond to ASCII code using a previously set full-widthcharacter code conversion table.

The code conversion module may convert a sorting order of EBCDIC, i.e., SPACE <full-width characters<uppercase Roman characters<lowercase Roman characters<numerals, into a sorting order of ASCII code, i.e., SPACE<numerals<uppercase Roman characters<lowercase Roman characters<full-width characters.

Another aspect of the present invention provides a migration method of converting work-specific application programs of a mainframe system into appropriate work-specific application programs for an open system, the migration method comprising the steps of: (a) decoding and obtaining sources of work-specific application programs used in the mainframe system and made of EBCDIC, in binary form; (b) converting the respective obtained sources of the workspecific application programs into ASCII code, hexadecimal characters being converted to correspond to ASCII code using a previously set hexadecimal code conversion table; (c) compiling the converted sources of the work-specific application programs and then linking the compiled sources of the work-specific application programs to corresponding work application programs; and (d) generating executable files in binary form from the compiled and linked work-specific application programs to execute them in an environment of the open system.

Still another aspect of the present invention provides a recording medium recording a program for executing the above-described migration method of converting an application program of a mainframe system into an appropriate application program for an open system.

### Advantageous Effects

According to the inventive migration apparatus and method for converting an application program of a mainframe system into an appropriate application program for an open system, it is possible to minimize errors and quickly convert an application program used in the mainframe system into an appropriate application program for the open system using various code conversion tables.

It is also possible to efficiently reuse a conventionally used application program via the rehosting process of converting a mainframe system into an open system.

### BRIEF DESCRIPTION OF THE DRAWINGS

FIG. 1 is a block diagram schematically illustrating a migration apparatus for converting an application program of a mainframe system into an appropriate application program for an open system according to an exemplary embodiment of the present invention; and

FIG. 2 is a flowchart illustrating a migration method of converting an application program of a mainframe system into an appropriate application program for an open system according to an exemplary embodiment of the present invention.

### MODE FOR THE INVENTION

Hereinafter, exemplary embodiments of the present invention will be described in detail. However, the present invention is not limited to the embodiments disclosed below, but can be implemented in various forms. Therefore, the following embodiments are described in order for this disclosure to be complete and enabling to those of ordinary skill in the art.

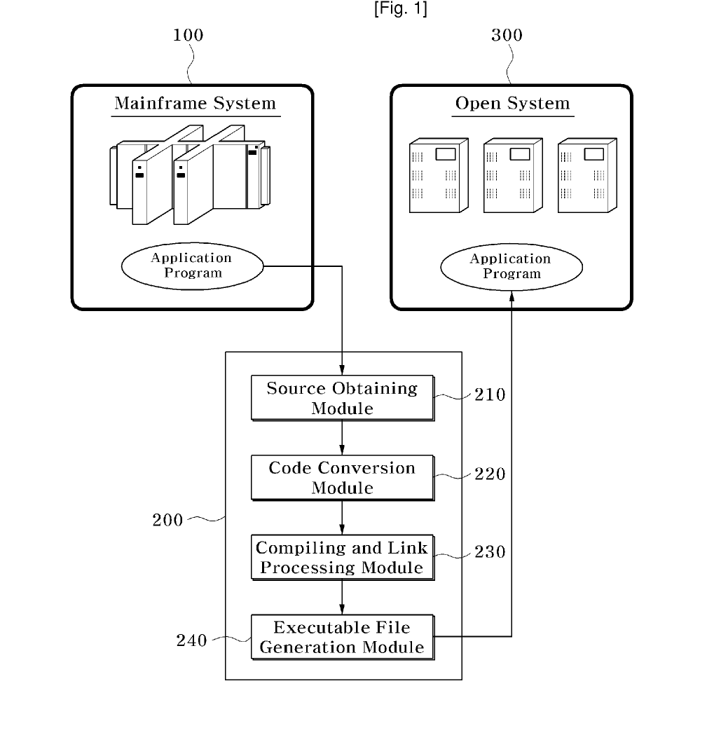

FIG. 1 is a block diagram schematically illustrating a migration apparatus for converting an application program of a mainframe system into an appropriate application program for an open system according to an exemplary embodiment of the present invention.

Referring to FIG. 1, a migration apparatus 200, which converts work-specific application programs of a mainframe system 100 into appropriate work-specific application programs for an open system 300, roughly comprises a source obtaining module 210, a code conversion module 220, a compiling and link processing module 230, and an executable file generation module 240.

Here, the mainframe system 100 processing company data is industrial terminology indicating a large scale computer manufactured by a large company, e.g., IBM Corporation. The mainframe system 100 is mainly used for performing computations required for the business activities of huge companies, such as large corporations and financial institutions, and is configured according to a centralized computing method rather than a distributed computing method.

Meanwhile, the open system 300 is industrial terminology indicating a method designed for enabling a link between hardware (H/W) and software (S/W) of different computer manufacturing companies and capable of being classified according to operating system, communication technique, and so on. The open system 300 mentioned here is a medium-scale computer having an operating system, e.g., UNIX, Linux, etc.

The source obtaining module 210 is connected with the mainframe system 100 and functions to decode and obtain respective sources of work-specific application programs made of Extended Binary Coded Decimal Interchange Code (EBCDIC) in binary form.

The code conversion module 220 functions to receive the sources of work-specific application programs obtained by the source obtaining module 210 and convert them each into American Standard Code for Information Interchange (ASCII) code.

In addition, the code conversion module 220 functions to convert hexadecimal characters to correspond to ASCII code using a previously set hexadecimal code conversion table (refer to http://www.simotime.com/asc2ebc1.htm).

In addition, the code conversion module 220 functions to convert special characters, e.g., “[”, “]”, “|”, etc., to correspond to ASCII code using a previously set special-character code conversion table.

In addition, the code conversion module 220 functions to convert variables, e.g., NAME, PREFETCH, AUTO, CRT, etc., used as reserved words in the open system 300, to correspond to ASCII code using a previously set reserved-word code conversion table.

In addition, the code conversion module 220 functions to convert full-width characters to correspond to ASCII code using a previously set full-width-character code conversion table.

In addition, the code conversion module 220 functions to convert the sorting order of EBCDIC, i.e., SPACE<full-width characters<uppercase Roman characters<lowercase Roman characters<numerals, into the sorting order of ASCII code, i.e., SPACE<numerals<uppercase Roman characters<lowercase Roman characters<full-width characters.

The compiling and link processing module 230 functions to receive the sources of work-specific application programs converted by the code conversion module 220, compile them, and then bundle the compiled sources of work-specific application programs as the corresponding work application programs.

The executable file generation module 240 functions to receive the work-specific application programs processed by the compiling and link processing module 230 and generate executable files in binary form to execute them in the environment of the open system 300.

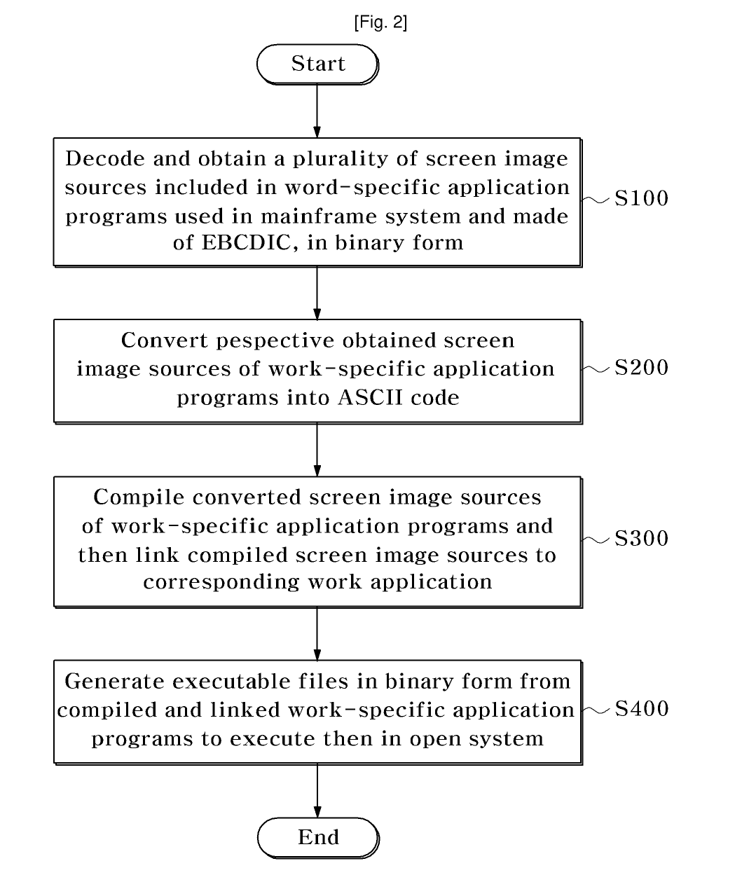

FIG. 2 is a flowchart illustrating a migration method of converting an application program of a mainframe system into an appropriate application program for an open system according to an exemplary embodiment of the present invention.

Referring to FIGS. 1 and 2, first, the sources of work-specific application programs made of EBCDIC used in the mainframe system 100 are decoded and obtained in binary form by the source obtaining module 210 (step 100).

Subsequently, the respective sources of work-specific application programs obtained in step 100 are converted into ASCII code by the code conversion module 220 (step 200).

Here, when hexadecimal characters are used in an application program of the mainframe system 100, hexadecimal values are changed due to difference between EBCDIC and ASCII code during the conversion. Thus, hexadecimal values are converted to correspond to ASCII code using a previously set hexadecimal code conversion table (refer to http://www.simotime.com/asc2ebc1.htm).

For example, according to a sentence “MOVE X ‘D0658B69’ TO WK-VAR,” the value of “□□” is input to WK-VAR in the mainframe system 100. In the open system 300, however, the hexadecimal value of “□□” is X ‘C7D1B1DB’, and thus the full-width characters get broken down.

In addition, special characters, e.g., “[”, “]”, “|”, etc., are converted to correspond to ASCII code using a previously set special-character code conversion table.

For example, when a sentence “MOVE ‘|’ TO XXXX” is converted into ASCII code used in the open system 300, it is broken and converted into “MOVE ‘? TO XXXX.”

In addition, variables, e.g., NAME, PREFETCH, AUTO, CRT, etc., used as reserved words in the open system 300 are converted to correspond to ASCII code using a previously set reserved-word code conversion table.

In addition, full-width characters are converted to correspond to ASCII code using a previously set full-width character code conversion table.

In addition, the sorting order of EBCDIC, i.e., SPACE<full-width characters<uppercase Roman characters<lowercase Roman characters<numerals, is converted into the sorting order of ASCII code, i.e., SPACE<numerals<uppercase Roman characters<lowercase Roman characters<full-width characters.

More specifically, due to the difference in sorting order between EBCDIC and ASCII code, problems occur when a variable having a letter together with a numeral is input for size comparison, section setting, and so on.

For example, according to EBCDIC, a sentence “BETWEEN ‘AA’ TO ‘99’” is read like this: data from AA to 99 is loaded. According to ASCII code, however, 99 is smaller than AA and thus no data is loaded.

For another example, according to EBCDIC, a sentence “when RETURN-CODE is ‘Y’, and RETURN-CODE>‘0’, it is an error” is processed normally because ‘Y’ is smaller than ‘0’. According to ASCII code, however, ‘Y’ is larger than ‘0’, thus incurring an error.

Subsequently, by the compiling and link processing module 230, the sources of work-specific application programs converted in step 200 are compiled and then linked to the corresponding work application programs (step 300).

Finally, executable files are generated in binary form by the executable file generation module 240 so as to execute the work-specific application programs compiled and linked in step 300 (step 400).

Meanwhile, the migration method of converting an application program of a mainframe system into an appropriate application program for an open system according to an exemplary embodiment of the present invention can be stored on a computer-readable recording medium using a computer code. The computer-readable recording medium may be any recording device storing data that can be read by a computer system.

For example, the computer-readable recording medium may be a read-only memory (ROM), a random-access memory (RAM), a compact disk read-only memory (CD-ROM), a magnetic tape, a hard disk, a floppy disk, a mobile storage device, a nonvolatile memory (flash memory), an optical data storage device, and so on. Also, the recording medium may be carrier waves, e.g., transmission over the Internet.

In addition, the computer-readable recording medium may be distributed among computer systems connected via a communication network and stored in the form of a code that can be read and executed by a de-centralized method.

While the invention has been shown and described with reference to certain exemplary embodiments of a migration apparatus and method for converting an application program of a mainframe system into an appropriate application program for an open system, it will be understood by those skilled in the art that various changes in form and details may be made therein without departing from the spirit and scope of the invention as defined by the appended claims.

1. A migration apparatus for converting work-specific application programs of a mainframe system into appropriate work-specific application programs for an open system, the migration apparatus comprising:
a source obtaining module connected with the mainframe system, and decoding and obtaining sources of the work-specific application programs made of Extended Binary Coded Decimal Interchange Code (EBCDIC) in binary form;
a code conversion module converting the respective sources of the work-specific application programs obtained by the source obtaining module into American Standard Code for Information Interchange (ASCII) code, hexadecimal characters being converted to correspond to ASCII code using a previously set hexadecimal code conversion table;
a compiling and link processing module compiling the sources of the work-specific application programs converted by the code conversion module and then bundling the compiled sources of the work-specific application programs with corresponding work application programs; and
an executable file generation module generating executable files in binary form from the work-specific application programs processed by the compiling and link processing module to execute them in an environment of the open system.

2. The migration apparatus of claim 1, wherein the mainframe system is a mainframe environment of IBM Corporation, and the open system is a UNIX environment.

3. The migration apparatus of claim 1, wherein the code conversion module converts special characters, e.g., “[”, “]”, and “|”, to correspond to ASCII code using a previously set special-character code conversion table.

4. The migration apparatus of claim 1, wherein the code conversion module converts variables, e.g., NAME, PREFETCH, AUTO, and CRT, used as reserved words in the open system to correspond to ASCII code using a previously set reserved-word code conversion table.

5. The migration apparatus of claim 1, wherein the code conversion module converts full-width characters to correspond to ASCII code using a previously set full-width-character code conversion table.

6. The migration apparatus of claim 1, wherein the code conversion module converts a sorting order of EBCDIC, i.e., SPACE<full-width characters<uppercase Roman characters<lowercase Roman characters<numerals, into a sorting order of ASCII code, i.e., SPACE<numerals<uppercase Roman characters<lowercase Roman characters<full-width characters.

7. A migration method of converting work-specific application programs of a mainframe system into appropriate work-specific application programs for an open system, the migration method comprising the steps of:
(a) decoding and obtaining sources of work-specific application programs used in the mainframe system and made of Extended Binary Coded Decimal Interchange Code (EBCDIC), in binary form;
(b) converting the respective obtained sources of the work-specific application programs into American Standard Code for Information Interchange (ASCII) code, hexadecimal characters being converted to correspond to ASCII code using a previously set hexadecimal code conversion table;
(c) compiling the converted sources of the work-specific application programs and then linking the compiled sources of the work-specific application programs to corresponding work application programs; and
(d) generating executable files in binary form from the compiled and linked work-specific application programs to execute them in an environment of the open system.

8. The migration method of claim 7, wherein in step (b), special characters, e.g., “[”, “]”, and “|”, are converted to correspond to ASCII code using a previously set special-character code conversion table.

9. The migration method of claim 7, wherein in step (b), variables, e.g., NAME, PREFETCH, AUTO, and CRT, used as reserved words in the open system are converted to correspond to ASCII code using a previously set reserved-word code conversion table.

10. The migration method of claim 7, wherein in step (b), full-width characters are converted to correspond to ASCII code using a previously set full-width-character code conversion table.

11. The migration method of claim 7, wherein in step (b), a sorting order of EBCDIC, i.e., SPACE<full-width characters<uppercase Roman characters<lowercase Roman characters<numerals, is converted into a sorting order of ASCII code, i.e., SPACE<numerals<uppercase Roman characters<lowercase Roman characters<full-width characters.

12. A computer-readable recording medium recording a program capable of executing the migration method of any one of claims 7 to 11.
